(19) United States
(12) Patent Application Publication
(10) Pub. No.: US 2025/0244744 A1
(43) Pub. Date: Jul. 31, 2025

(54) LEVERAGING ROBOTIC PROCESS AUTOMATION FOR MAXIMUM EFFICIENCY IN GENERATING DAILY REPORT

(71) Applicant: SAUDI ARABIAN OIL COMPANY, Dhahran (SA)

(72) Inventors: Firas A. Abussaud, Dhahran (SA); Nourah A. Almulla, Al Khobar (SA); Abdulaziz K. Almobarak, Dhahran (SA)

(73) Assignee: SAUDI ARABIAN OIL COMPANY, Dhahran (SA)

(21) Appl. No.: 18/425,437

(22) Filed: Jan. 29, 2024

(51) Int. Cl. G05B 19/4155

(52) U.S. Cl. CPC G05B 19/4155; G05B 2219/50391

(57) ABSTRACT

A method and a system are disclosed. The method includes obtaining raw data from a plurality of sources. The plurality of sources includes sensor readings, generated reports, operational parameters, and production rates, wherein the raw data includes organized data and unorganized data. The method further includes integrating, using a robotic process automation (RPA), the organized data and the unorganized data and performing a plurality of statistical calculations on the integrated data. A report is generated based on the performed statistical calculations and a maintenance operation is performed in response to the report.

### BACKGROUND

Large worldwide wells require intensive monitoring. Ensuring maximum production and maintaining integrity of these wells that operate in high pressure high temperature (HP/HT) environment poses a huge challenge. A widely used process of monitoring is through the Gas Morning Report which provides well production parameters daily. However, there is, currently, no specific process to complete this report as engineers are currently copying data manually from different structured and unstructured data sources. This process is tedious and highly subjected to human errors and may lead to decrease in the credibility of the report which may pose HSE issues and waste a lot of engineers' time.

The RPA uses automation technologies to mimic tasks of human workers, such as extracting data, filling in forms, moving files, etc. The RPA combines APIs and user interface (UI) interactions to integrate and perform repetitive tasks between enterprise and productivity applications. By deploying scripts which emulate human processes, RPA tools complete autonomous execution of various activities and transactions across unrelated software systems.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method, the method including obtaining raw data from a plurality of sources. The plurality of sources includes sensor readings, generated reports, operational parameters, and production rates, wherein the raw data includes organized data and unorganized data. The method further includes integrating, using a robotic process automation (RPA), the organized data and the unorganized data and performing a plurality of statistical calculations on the integrated data. A report is generated based on the performed statistical calculations and a maintenance operation is performed in response to the report.

Embodiments disclosed herein generally relate to a non-transitory computer readable medium storing instructions executable by a computer processor. The instructions include functionality for obtaining raw data from a plurality of sources. The plurality of sources includes sensor readings, generated reports, operational parameters, and production rates, wherein the raw data includes organized data and unorganized data. The organized data and the unorganized data are integrated, using a robotic process automation (RPA), and a plurality of statistical calculations are performed on the integrated data. A report is generated based on the performed statistical calculations and a maintenance operation is performed in response to the report.

Embodiments disclosed herein generally relate to a system. The system includes a well logging system. The system further includes a computer processor, where the computer processor is coupled to the well logging system. The computer processor includes functionality for obtaining raw data from a plurality of sources. The plurality of sources includes sensor readings, generated reports, operational parameters, and production rates, wherein the raw data includes organized data and unorganized data. The organized data and the unorganized data are integrated, using a robotic process automation (RPA), and a plurality of statistical calculations are performed on the integrated data. A report is generated based on the performed statistical calculations and a maintenance operation is performed in response to the report.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a system according to embodiments of the present disclosure.

FIG. 2 shows a flowchart in accordance with one or more embodiments.

FIG. 3A shows an exemplary flowchart in accordance with one or more embodiments.

FIG. 3B shows a system according to embodiments of the present disclosure.

FIG. 4 shows a computer system in accordance with one or more embodiments.

### DETAILED DESCRIPTION

In the following detailed description of embodiments disclosed herein, numerous specific details are set forth in order to provide a more thorough understanding disclosed herein. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

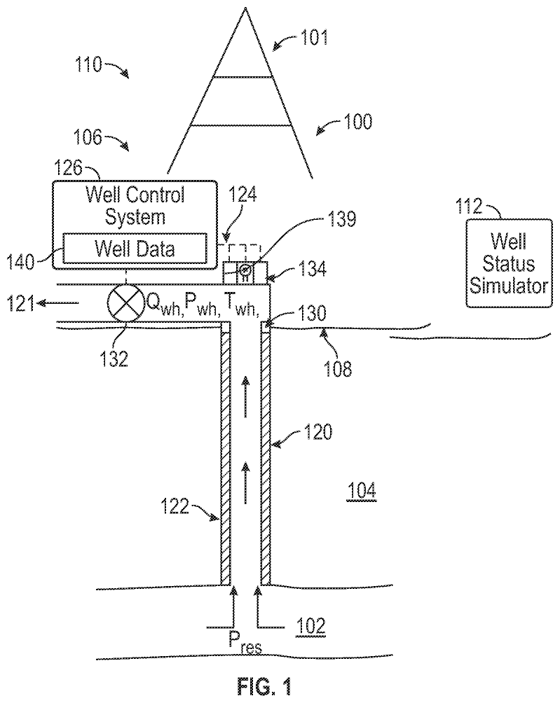

In the following description of FIGS. 1-4, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments disclosed herein provide a method and system for generating a report using robot process automation (RPA). Specifically, the method for generating a report using RPA leverages the advanced capabilities automation and the employment of smart machines. More specifically, the method utilizes the RPA technology and programs it in a way that enables the RPA technology to read both structured and unstructured data. The RPA automates and streamlines the process generating a report using software robots (RPA bots). The RPA bots handle and perform all the time-consuming and repetitive tasks without any human intervention. The tasks may include, at least, data collection, statistical calculations, and preparing the final report that can be reviewed by the dedicated engineers before publishing it to management.

In one or more embodiments, this method may be implemented on already existing hardware packages as a plug-in module. The plug-in module may be deployed on the existing analytics setup. Initially the hardware package may be deployed as a standalone setup, with an interface provided to the driller to run Graphical User Interface (GUI). That ensures that the development and roll-out phase of the project are easier to implement, without requiring a permanent rig fixture. Alternatively, the system may be integrated directly to the rig to perform a maintenance operation.

The reports currently implemented in the industry require a specific process to complete these reports as engineers copy data manually from different structured and unstructured data sources including email attachments received from several sources, production reports, files from shared folders, data from web application, engineering calculations, etc. After that a report is prepared manually using a Word document which is then saved and converted to pdf file and shared with upper management. This process may be tedious and highly subjected to human errors and may lead to decrease in the credibility of the report which may pose health, safety, and environment issues.

Embodiments disclosed herein enable operations in wells which require intensive monitoring, where ensuring maximum production and maintaining integrity of these wells that operate in high pressure high temperature (HP/HT) environment poses a huge challenge. The report is critical to ensure the wells are operating within production guidelines, annuli pressures are within safe operating limit, and choke valves are controlling the rate safely, etc.

Additionally, a predictive maintenance may be performed based on the results of the report. Specifically, the predictive maintenance involves making decisions based on the analyzed data from the reports and predicting a possible equipment failure, by studying the patterns and trends in the data. The predictive maintenance may help reduce the cost of maintenance by allowing for maintenance to be performed only when needed, rather than on a fixed schedule. Additionally, the predictive maintenance may help reduce unnecessary downtime and maintenance costs. By predicting equipment failure before it occurs, incidents may be prevented by allowing for timely maintenance or replacement of faulty equipment. The embodiments described in this disclosure may enable real-time monitoring of equipment performance, allowing for early detection of potential issues and faster response times.

Additionally, embodiments described in this disclosure may provide data-driven insights into equipment performance, allowing for more informed decision-making and continuous improvement. By reducing unexpected downtime and optimizing maintenance schedules, the equipment failure prediction may lead to cost savings for the operator and the use of the invention for predictive maintenance of equipment has the potential to improve equipment reliability, reduce maintenance costs, and increase overall efficiency.

FIG. 1 shows a schematic diagram in accordance with one or more embodiments. As shown in FIG. 1, a well environment (100) includes a hydrocarbon reservoir (“reservoir”) (102) located in a subsurface hydrocarbon-bearing\formation (“formation”) (104) and a well system (106). The hydrocarbon-bearing formation (104) may include a porous or fractured rock formation that resides underground, beneath a geological surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102).

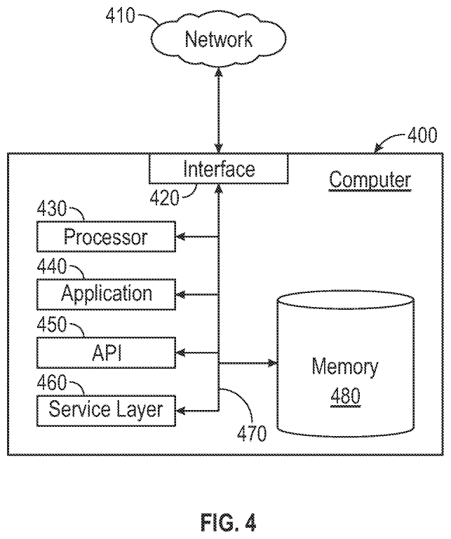

In some embodiments, the well system (106) includes a rig (101), a drilling system (110), a logging system (111), a well status simulator (112), a wellbore (120), a well sub-surface system (122), a well surface system (124), and a well control system (“control system”) (126). The drilling system (110) may include a drill string, a drill bit, and a mud circulation system for use in drilling the wellbore (120) into the formation (104). The logging system (111) may include one or more logging tools, for use in generating well logs, based on the sensing system (134), of the formation (104). The well control system (126) may control various operations of the well system (106), such as well production operations, well drilling operation, well completion operations, well maintenance operations, and reservoir monitoring, assessment and development operations. In some embodiments, the well control system (126) includes a computer system that is the same as or similar to that of a computer system (400) described below in FIG. 4 and the accompanying description.

The rig (101) is a combination of equipment used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment.

The wellbore (120) includes a bored hole (i.e., borehole) that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “downhole” end of the wellbore (120). The wellbore (120) may facilitate the circulation of drilling fluids during drilling operations, flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) lowered into the hydrocarbon-bearing formation (104) or the reservoir (102) during monitoring operations (e.g., during in situ logging operations).

In some embodiments, during operation of the well system (106), the well control system (126) collects and records well data (140) for the well system (106). During drilling operation of the well (106), the well data (140) may include mud properties, flow rates measured by a flow rate sensor (139), drill volume and penetration rates, formation characteristics, etc. To drill a subterranean well or wellbore (120), a drill string (110), including a drill bit and drill collars to weight the drill bit, may be inserted into a pre-drilled hole and rotated to cut into the rock at the bottom of the hole, producing rock cuttings. Commonly, the drilling fluid, or drilling mud, may be utilized during the drilling process. To remove the rock cuttings from the bottom of the wellbore (120), drilling fluid is pumped down through the drill string (110) to the drill bit. The drilling fluid may cool and lubricate the drill bit and provide hydrostatic pressure in the wellbore (120) to provide support to the sidewalls of the wellbore (120). The drilling fluid may also prevent the sidewalls from collapsing and caving in on the drill string (110) and prevent fluids in the downhole formations from flowing into the wellbore (120) during drilling operations. Additionally, the drilling fluid may lift the rock cuttings away from the drill bit and upwards as the drilling fluid is recirculated back to the surface. The drilling fluid may transport rock cuttings from the drill bit to the surface, which can be referred to as “cleaning” the wellbore (120), or hole cleaning.

In some embodiments, the well data (140) are recorded in real-time, and are available for review or use within seconds, minutes or hours of the condition being sensed (e.g., the measurements are available within 1 hour of the condition being sensed). In such an embodiment, the well data (140) may be referred to as “real-time” well data (140). Real-time well data (140) may enable an operator of the well (106) to assess a relatively current state of the well system (106), and make real-time decisions regarding a development of the well system (106) and the reservoir (102), such as on-demand adjustments in drilling fluid and regulation of production flow from the well.

In some embodiments, the well surface system (124) includes a wellhead (130). The wellhead (130) may include a rigid structure installed at the “up-hole” end of the wellbore (120), at or near where the wellbore (120) terminates at the geological surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of production (121). For example, a production valve (132) may be fully opened to enable the unrestricted flow of production (121) from the wellbore (120), the production valve (132) may be partially opened to partially restrict (or “throttle”) the flow of production (121) from the wellbore (120), and production valve (132) may be fully closed to fully restrict (or “block”) the flow of production (121) from the wellbore (120), and through the well surface system (124).

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead. As such, the choke assembly may include a set of high-pressure valves and at least two chokes. These chokes may be fixed or adjustable or a mix of both. Redundancy may be provided so that if one choke has to be taken out of service, the flow can be directed through another choke. In some embodiments, pressure valves and chokes are communicatively coupled to the well control system (126). Accordingly, a well control system (126) may obtain wellhead data regarding the choke assembly as well as transmit one or more commands to components within the choke assembly in order to adjust one or more choke assembly parameters.

Keeping with FIG. 1, in some embodiments, the well surface system (124) includes a surface sensing system (134). The surface sensing system (134) may include sensors for sensing characteristics of substances, including production (121), passing through or otherwise located in the well surface system (124). The characteristics may include, for example, pressure, temperature and flow rate of production (121) flowing through the wellhead (130), or other conduits of the well surface system (124), after exiting the wellbore (120). The surface sensing system (134) may also include sensors for sensing characteristics of the rig (101), such as bit depth, hole depth, drilling fluid flow, hook load, rotary speed, etc.

In one or more embodiments, the well system (106) includes the well status simulator (112). The well status simulator (112) may be interfaced with the RPA bot. The well status simulator (112) may include hardware and/or software with functionality for generating equipment failure prediction score, initiating and performing maintenance operations, and/or performing one or more reservoir simulations, based on the report generated from the RPA bot. For example, the well status simulator (112) may store the historic data, maintenance records, operational parameters, production targets obtained by the sensors and generated in the report. For this purpose, the generator may include memory with one or more data structures, such as a buffer, a table, an array, or any other suitable storage medium. The well status simulator (112) may further, at least, analyze the historic data, sensor readings, maintenance records, operational parameters, production targets, determine an equipment failure score. While the well status simulator (112) is shown at a well site, in some embodiments, the well status simulator (112) may be located remotely from the well site. In some embodiments, well status simulator (112) may include a computer system that is similar to the computer system (400) described below with regard to FIG. 4 and the accompanying description.

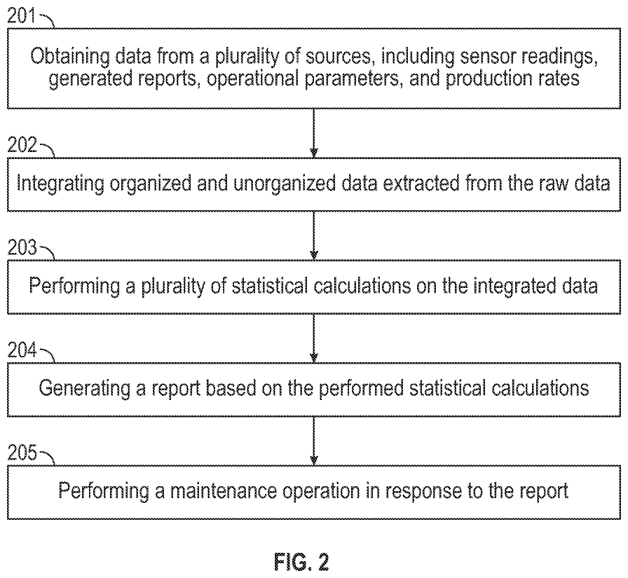

FIG. 2 shows a flowchart in accordance with one or more embodiments for generating a report using robot process automation (RPA). Specifically, in Block 201, data is obtained from a plurality of sources. Specifically, the data may include inputs such as sensor readings, maintenance records, operational parameters, production targets, etc. In one or more embodiments the sensor readings, the maintenance records, the operational parameters, and production targets may be obtained in real-time. In other embodiments, the sensor readings, the maintenance records, the operational parameters, and production targets may be obtained sequentially or immediately after drilling operations are performed.

The sensor readings may include data regarding a plurality of well parameters. The data regarding the plurality of well parameters includes, at least, the data about pressure, temperature, flow rate, and vibration. The sensor readings may be obtained using specialized tools such as, as least, thermometers, pressure gauges, and flowmeters (e.g., venturi meters, turbine meters, ultrasonic meters, electromagnetic meters, etc.). Further, the maintenance records include data about date of last maintenance, types of maintenance performed, and reason for the last maintenance. The operational parameters include data about time of the equipment's operation, load of the equipment, and speed of the equipment. Further, the production targets include data on expected performance of the equipment.

In one or more embodiments, the data may be previously obtained and processed. Specifically, the data may be stored in a plurality of attachments and received over an email. Additionally, the data may be stored in spreadsheets. For example, the sensor readings, the maintenance records, and the operational parameters may be stored in a remote real-time server and obtained as a spreadsheet. Further, the data may be stored in at least, a web application format, a word processing application, and a plurality of maps. Additionally, the obtained data may be organized and unorganized data.

In Block 202, the organized and unorganized data is integrated. Specifically, the organized data is data that is structured, labeled, and systematically stored. Such data allows more efficient retrieval, manipulation, and analysis. The organized data may be stored in databases, with defined tables, columns, and rows. Additionally, the organized data may be stored in organized files and folders with predetermined naming conventions. Further, the unorganized data may be in raw or unprocessed form. The unorganized data may include text documents without distinct categorization, unsorted lists, or other raw sensor data collected without a specific structure or format including the user data, such as safety suggestions, compliance reports, site assessment reports, user-submitted innovative ideas, etc.

The process of integrating organized and unorganized data may include manual or automatic structuring and categorizing of the unorganized data to fit within an organized framework. The integration process may include cleaning, sorting, and transforming the structured and unstructured data into one of the formats compatible with the organized frameworks, such as the databases. For example, data cleaning is the process of fixing or removing incorrect, corrupted, incorrectly formatted, duplicate, or incomplete data within a dataset. When combining multiple data sources, such as different organized and unorganized data, the data may be duplicated or mislabeled.

The cleaning of data includes removing unwanted observations from a dataset, including duplicate observations or irrelevant observations. The duplicate observations may occur during data collection. When data sets are combined from multiple places, including organized and unorganized datasets, or received from clients or multiple departments, duplicate data may be created. Irrelevant data are the data that does not fit into the specific problem being analyzed. For example, analyzing data regarding a particular well, but the dataset including data regarding a different well, the irrelevant data should be removed. This can make analysis more efficient and minimize distraction from the primary target.

Further, the sorting of data is a process that involves arranging the data into a meaningful order to make it easier to understand, analyze or visualize the data. When working with well data, sorting is a common method used for visualizing data in a form that makes it easier to comprehend and visualize the knowledge the data is showing. Sorting can be done with raw data or at an aggregated level, such as a in a table, chart, data structure, or some other aggregated or summarized output. The data is typically sorted based on actual values, counts or percentages, in either ascending or descending order, but can also be sorted based on the variable value labels. Value labels are metadata found in some programs which allow the researcher to store labels for each value option of a categorical question. Additionally, the sorting may be performed by multiple variables. This type of sorting may be executed in a predetermined variable priority, for example, a data set containing a location of the oil field as a primary sorting parameter and output of a well as a secondary sorting parameter.

Additionally, data transformation is the process of converting data from one format or structure into another. Transformation processes can also be referred to as data wrangling, or data munging, transforming, and mapping data from one raw data form into predetermined format for warehousing and analyzing. The data transformation may be used when data needs to be converted to match that of the destination system. Specifically, the data transformation process consists of identifying and understanding the data in an original source format. This may be accomplished with the help of a data profiling tool. This step helps in deciding how data needs to be processed in order to get it into the desired format.

In Block 203, a plurality of statistical calculations are performed on the integrated data. The statistical calculation of the integrated data includes mathematical methods to analyze data, summarize information, and make conclusions or predictions. The statistical calculations may include techniques including mean, median, mode, standard deviation, correlation between relationships between variables, and hypothesis testing to draw conclusions about a population data based on a sample data. The statistical calculations are performed to understand and determine patterns and trends within data and to help with a decision making regarding various aspects of the oil field.

Specifically, the statistical calculations may be performed to calculate metrics of each oil field. Specifically, the statistical calculations may be performed on the field data, the sensor data, the production rates, and real-time updates for each oil field to assess the status of the oil fields and to obtain more meaningful and organized information regarding the oil fields.

In one or more embodiments, the statistical calculations may analyze porosity and permeability to data to help understanding the rock's ability to hold and transmit fluids. Further, the statistical calculations may be used as a curve analysis to predict future production rates based on the historical and real-time production data, as well as to estimate reserves and optimize production strategies. An analysis of drilling data may be performed to optimize drilling operations, assess drilling risks, and predict drilling performance. Statistical methods such as kriging and variogram analysis may be used for spatial interpolation od data in reservoir to predict properties at unsampled locations and to quantify spatial variability and correlation between data points in the reservoir.

In one or more embodiments, a specific process may be employed within the automation to populate all the data required in the report in frequencies of 1 data point per minute. This allows the RPA to run the statistical calculation and include the result in the final report.

Further, in Block 204, a report is generated based on the results of the performed statistical calculations. More specifically, in one or more embodiments, the generated reports may include, but are not limited to, the statistical calculations and the obtained data, a report to the data management module by well name, service company, service name, date, period, etc., visualizing the results of statistical calculations, and a data delivery KPI report for non-technical actions. The generated report may also include prescriptive analytics to improve controlling the well.

In one or more embodiments, the report may include an action plan. The generated action plan may be triggered by the statistical analysis process and rely on a systematic and continuous monitoring of real-time and previously obtained data. The action plan delivers the results and proposed actions to multiple stakeholders, such as the user, the admin, a finance department, a contract department, and a management department. The action plan report provides the admin with the use of the statistical calculations and outputs to improve the program's performance, and to upgrade and add new features. The management department are provided with conclusions regarding the service provider evaluation and arbitration.

In Block 205, a maintenance operation is carried out, when the action report raises a flag. Specifically, the maintenance operation may include, at least, refurbishing equipment components and replacing damaged or worn-out wellbore components. In another example, the maintenance operation may include transmitting an electronic signal sent to an automated maintenance system for procuring and delivering wellbore equipment components to a system site for performing a maintenance operation of replacing or refurbishing the wellbore equipment components.

Specifically, a variety of maintenance procedures involve specific, tangible actions that are carried out on the wellbore equipment, that could follow the statistical prediction. A preventive maintenance may involve performing routine checks and inspections of the equipment to identify any potential issues before they lead to equipment failure. This may include checking the integrity of the valves, inspecting the condition of the mandrels, and assessing the performance of the compressors, etc.

Additionally, the statistical analysis prediction may also trigger predictive maintenance procedures, such as using the statistical analysis prediction to forecast when specific components of the wellbore equipment are likely to fail and scheduling maintenance activities accordingly. This can help to minimize downtime and optimize the overall efficiency of the oil production process. Further, the ensemble prediction may lead to corrective maintenance operation. If the ensemble prediction indicates a high likelihood of equipment failure, corrective actions such as repairing or replacing faulty components could be taken immediately to prevent the predicted failure.

The statistical analysis prediction may also trigger a condition-based maintenance, where maintenance tasks are only performed when certain indicators show signs of decreasing performance or upcoming failure. This involves monitoring the real-time condition of the wellbore equipment and performing maintenance activities based on the current state of the equipment. The condition of the equipment could be assessed using various sensor readings such as gas flow rate, pressure, and temperature. Further, the statistical analysis prediction may be used to implement a reliability-centered maintenance program involving identifying the components of the wellbore equipment that are most critical to the overall performance of the system and focusing the maintenance efforts on these components. The ensemble prediction could be used to identify the components that are most likely to fail and prioritize them for maintenance.

In some embodiments, the statistical analysis prediction could be used to implement a maintenance operation. If the statistical analysis prediction indicates a potential equipment failure, a remote-control system could be used to adjust the operating parameters of the wellbore lift equipment to prevent the failure. This could include adjusting the gas flow rate, pressure, or temperature to maintain the optimal operating conditions for the equipment.

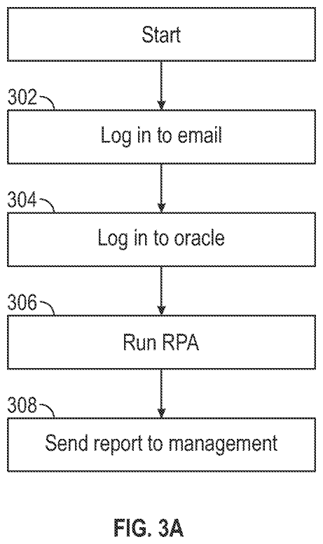

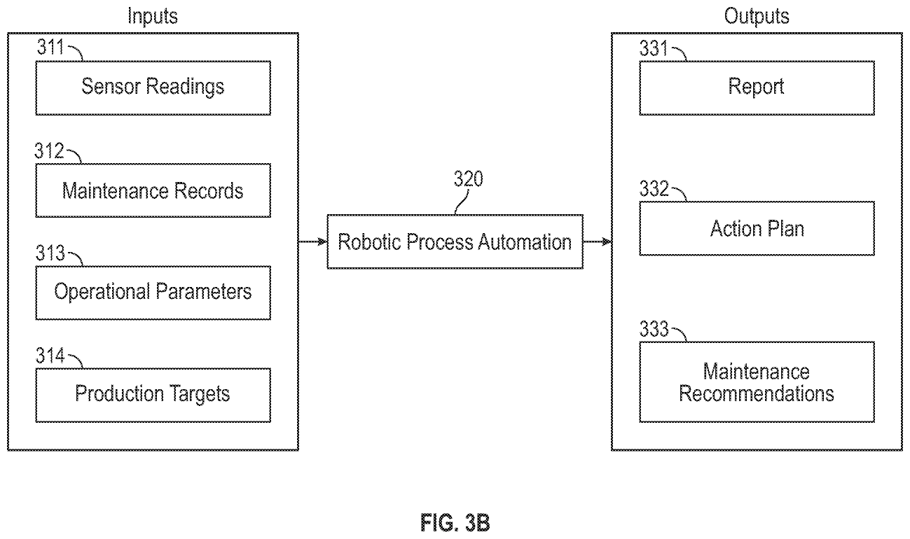

An exemplary flowchart and a model of architecture are shown in FIGS. 3A and 3B, respectively. Specifically, the model architecture represents the process of using RPA to generate a report based on various input features. Obtaining the data is the starting point of the process. The data may consist of various features such as sensor readings (311), maintenance records (312), operational parameters (313), and production targets (314).

In one or more embodiments, the data may be obtained from a plurality of sources and include structured and unstructured data. For exemplary purposes, the unorganized data may be received in a form of an email (302). Specifically, the unorganized data may be in raw or unprocessed form. The unorganized data may include text documents without distinct categorization, unsorted lists, or other raw sensor data collected without a specific structure including the user data, such as safety suggestions, compliance reports, site assessment reports, user-submitted innovative ideas, etc.

Additionally, the organized data may be accessed through a data logging software and a database management system (304) such as Oracle. Specifically, the organized data is data that is structured, labeled, and systematically store. The organized data may be stored in databases, with defined tables, columns, and rows. Additionally, the organized data may be stored in organized files and folders with predetermined naming conventions.

In one or more embodiments, after obtaining the input data (311-314) by gaining access to data repositories (e.g., email and Oracle), in Block 306 the RPA (320) may be started. The RPA (320) process starts by downloading email attachments (e.g., PDF, Word, and Excel), extracting data from different attachments, opening files from local and network drives, and reading real-time data. After gaining access to the data repositories and obtaining the data, the organized and unorganized data has to be integrated. The data may be integrate using manual or automatic structuring and categorizing of the unorganized data to fit within an organized framework. The integration process may include cleaning, sorting, and transforming the unstructured data into one of the formats compatible with the organized data, such as the databases.

Further, RPA (320) cleans the data by removing unwanted observations from a dataset, including duplicate observations or irrelevant observations. The clean data may be sorted by arranging the data into a meaningful order to make it easier to understand, analyze or visualize the data. Sorting can be done with raw data or at an aggregated level, such as a in a table, chart, or some other aggregated or summarized output. The data is typically sorted based on actual values, counts or percentages, in either ascending or descending order, but can also be sorted based on the variable value labels.

In one or more embodiments, the RPA (320) transforms the data from one format or structure into another. Transformation processes can also be referred to as data wrangling, or data munging, transforming, and mapping data from one raw data form into predetermined format for warehousing and analyzing. The data transformation may be used when data needs to be converted to match that of the destination system. This step helps in deciding how data needs to be processed in order to get it into the desired format.

Additionally, RPA (320) performs a plurality of statistical calculations on the integrated data. The statistical calculations may include techniques including mean, median, mode, standard deviation, correlation between relationships between variables, and hypothesis testing to draw conclusions about a population data based on a sample data. The statistical calculations are performed to understand and determine patterns and trends within data and to help with a decision making regarding various aspects of the oil field.

Further, in Block 308, a report (331) is generated based on the results of the performed statistical calculations. In one or more embodiments, the generated reports (331) may include, but are not limited to, a report (331) to the user statistical calculations and the obtained data, a report (331) to the data management module by well name, service company, service name, date, period, etc., visualizing the results of statistical calculations, and a data delivery KPI report for non-technical actions. The generated report (331) may also include prescriptive analytics to improve controlling the well. The data included in the report (331) may be organized into a word processing template such as Microsoft Word and/or converted to the portable document format (PDF). Further, the report in the PDF version may be sent as an attachment to the email.

Further, in one or more embodiments, the report (331) may include an action plan (332). The generated action plan (332) may be triggered by the statistical analysis process and rely on a systematic and continuous monitoring of real-time and previously obtained data and executed by the well status simulator (112) based on the report (331). Additionally, a maintenance operation (333) is carried out, when the action report (332) raises a flag. Specifically, the maintenance operation may include, at least, refurbishing equipment components and replacing damaged or worn-out wellbore components. In another example, the maintenance operation may include transmitting an electronic signal sent to an automated maintenance system for procuring and delivering wellbore equipment components to a system site for performing a maintenance operation of replacing or refurbishing the wellbore equipment components. Further, the maintenance recommendation may be used to adjust the operating parameters of the wellbore lift equipment to prevent the failure. This could include adjusting the gas flow rate, pressure, or temperature to maintain the optimal operating conditions for the equipment.

Embodiments disclosed herein may be implemented on any suitable computing device, such as the computer system shown in FIG. 4. The RPA bot is integrated to the computer system by being installed as a software to the computing device and being configured to perform automated tasks. Further, FIG. 4 is a block diagram of a computer system (400) used to provide computational functionalities associated with described algorithms, methods, functions, processes, flows, and procedures as described in the instant disclosure, according to an implementation. The illustrated computer (400) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (400) may include a computer that includes an input device, such as a keypad, keyboard, touch screen, or other device that can accept user information, and an output device that conveys information associated with the operation of the computer (400), including digital data, visual, or audio information (or a combination of information), or a GUI.

The computer (400) can serve in a role as a client, network component, a server, a database or other persistency, or any other component (or a combination of roles) of a computer system for performing the subject matter described in the instant disclosure. The illustrated computer (400) is communicably coupled with a network (410). In some implementations, one or more components of the computer (400) may be configured to operate within environments, including cloud-computing-based, local, global, or other environment (or a combination of environments).

At a high level, the computer (400) is an electronic computing device operable to receive, transmit, process, store, or manage data and information associated with the described subject matter. According to some implementations, the computer (400) may also include or be communicably coupled with an application server, e-mail server, web server, caching server, streaming data server, business intelligence (BI) server, or other server (or a combination of servers).

The computer (400) can receive requests over network (410) from a client application (for example, executing on another computer (400) and responding to the received requests by processing the said requests in an appropriate software application. In addition, requests may also be sent to the computer (400) from internal users (for example, from a command console or by other appropriate access method), external or third-parties, other automated applications, as well as any other appropriate entities, individuals, systems, or computers.

Each of the components of the computer (400) can communicate using a system bus (470). In some implementations, any or all of the components of the computer (400), both hardware or software (or a combination of hardware and software), may interface with each other or the interface (420) (or a combination of both) over the system bus (470) using an application programming interface (API) (450) or a service layer (460) (or a combination of the API (450) and service layer (460). The API (450) may include specifications for routines, data structures, and object classes. The API (450) may be either computer-language independent or dependent and refer to a complete interface, a single function, or even a set of APIs. The service layer (460) provides software services to the computer (400) or other components (whether or not illustrated) that are communicably coupled to the computer (400). The functionality of the computer (400) may be accessible for all service consumers using this service layer. Software services, such as those provided by the service layer (460), provide reusable, defined business functionalities through a defined interface. For example, the interface may be software written in JAVA, C++, or other suitable language providing data in extensible markup language (XML) format or other suitable format. While illustrated as an integrated component of the computer (400), alternative implementations may illustrate the API (450) or the service layer (460) as stand-alone components in relation to other components of the computer (400) or other components (whether or not illustrated) that are communicably coupled to the computer (400). Moreover, any or all parts of the API (450) or the service layer (460) may be implemented as child or sub-modules of another software module, enterprise application, or hardware module without departing from the scope of this disclosure.

The computer (400) includes an interface (420). Although illustrated as a single interface (420) in FIG. 4, two or more interfaces (420) may be used according to particular needs, desires, or particular implementations of the computer (400). The interface (420) is used by the computer (400) for communicating with other systems in a distributed environment that are connected to the network (410). Generally, the interface (420 includes logic encoded in software or hardware (or a combination of software and hardware) and operable to communicate with the network (410). More specifically, the interface (420) may include software supporting one or more communication protocols associated with communications such that the network (410) or interface's hardware is operable to communicate physical signals within and outside of the illustrated computer (400).

The computer (400) includes at least one computer processor (430). Although illustrated as a single computer processor (430) in FIG. 4, two or more processors may be used according to particular needs, desires, or particular implementations of the computer (400). Generally, the computer processor (430) executes instructions and manipulates data to perform the operations of the computer (400) and any algorithms, methods, functions, processes, flows, and procedures as described in the instant disclosure.

The computer (400) also includes a memory (480) that holds data for the computer (400) or other components (or a combination of both) that can be connected to the network (410). For example, memory (480) can be a database storing data consistent with this disclosure. Although illustrated as a single memory (480) in FIG. 4, two or more memories may be used according to particular needs, desires, or particular implementations of the computer (400) and the described functionality. While memory (480) is illustrated as an integral component of the computer (400), in alternative implementations, memory (480) can be external to the computer (400).

The application (440) is an algorithmic software engine providing functionality according to particular needs, desires, or particular implementations of the computer (400), particularly with respect to functionality described in this disclosure. For example, application (440) can serve as one or more components, modules, applications, etc. Further, although illustrated as a single application (440), the application (440) may be implemented as multiple applications (440) on the computer (400). In addition, although illustrated as integral to the computer (400), in alternative implementations, the application (440) can be external to the computer (400).

There may be any number of computers (400) associated with, or external to, a computer system containing computer (400), each computer (400) communicating over network (410). Further, the term “client,” “user,” and other appropriate terminology may be used interchangeably as appropriate without departing from the scope of this disclosure. Moreover, this disclosure contemplates that many users may use one computer (400), or that one user may use multiple computers (400).

In some embodiments, the computer (400) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Embodiments disclosed herein leverage the power of Robotic Process Automation to read structured and unstructured data from multiple different data sources, implement engineering calculations, and present all these insights in clean unified report to management. The process is automated such that the engineer that generates this report before a meeting, for example, needs only to log into the system and run the RPA bot in order to generate this report.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining, using a computer processor, raw data from a plurality of sources, the plurality of sources including sensor readings, generated reports, operational parameters, and production rates, wherein the raw data includes organized data and unorganized data;
integrating, using the computer processor and a robotic process automation (RPA), the organized data and the unorganized data;
performing, using the computer processor and the RPA, a plurality of statistical calculations on the integrated data;
generating, using the computer processor and the RPA, a report based on the performed statistical calculations; and
performing, using the computer processor, a maintenance operation in response to the report.

2. The method of claim 1, wherein integrating the organized data and unorganized data extracted from the raw data comprises:
cleaning, using the computer processor and the RPA, the organized data and unorganized data by removing incorrect, corrupted, incorrectly formatted, duplicate, or incomplete organized data and unorganized data;
sorting, using the computer processor and the RPA, the cleaned data according to a predetermined order; and
transforming, using the computer processor and the RPA, the sorted data into a predetermined format.

3. The method of claim 2, wherein transforming the sorted data includes data wrangling and mapping data into the predetermined format.

4. The method of claim 1, wherein the statistical calculations may be performed on field data, sensor data, production rates, and real-time updates for a plurality of oil fields.

5. The method of claim 4, wherein the statistical calculations predict, using a curve analysis, a future production rate, estimate oil reserves, and optimize production strategies based on historical and real-time production data.

6. The method of claim 1, wherein the maintenance operation comprises replacing wellbore equipment components.

7. The method of claim 1, wherein the maintenance operation comprises adjusting operating parameters of a wellbore equipment to prevent failure.

8. A non-transitory computer readable medium storing instructions executable by a computer processor, the instructions comprising functionality for:
obtaining raw data from a plurality of sources, the plurality of sources including sensor readings, generated reports, operational parameters, and production rates, wherein the raw data includes organized data and unorganized data;
integrating, using a robotic process automation (RPA), the organized data and the unorganized data;
performing, using the RPA, a plurality of statistical calculations on the integrated data;
generating, using the RPA, a report based on the performed statistical calculations; and
performing, using the computer processor, a maintenance operation in response to the report.

9. The non-transitory computer readable medium of claim 8, wherein integrating the organized data and unorganized data extracted from the raw data comprises:
cleaning, using the computer processor and the RPA, the organized data and unorganized data by removing incorrect, corrupted, incorrectly formatted, duplicate, or incomplete organized data and unorganized data;
sorting, using the computer processor and the RPA, the cleaned data according to a predetermined order; and
transforming, using the computer processor and the RPA, the sorted data into a predetermined format.

10. The non-transitory computer readable medium of claim 9, wherein transforming the sorted data includes data wrangling and mapping data into the predetermined format.

11. The non-transitory computer readable medium of claim 8, wherein the statistical calculations may be performed on field data, sensor data, production rates, and real-time updates for a plurality of oil fields.

12. The non-transitory computer readable medium of claim 11, wherein the statistical calculations predict, using a curve analysis, a future production rate, estimate oil reserves, and optimize production strategies based on historical and real-time production data.

13. The non-transitory computer readable medium of claim 8, wherein the maintenance operation comprises replacing wellbore equipment components.

14. The non-transitory computer readable medium of claim 8, wherein the maintenance operation comprises adjusting operating parameters of a wellbore equipment to prevent failure.

15. A system comprising:
a well logging system; and
a computer processor, wherein the computer processor is coupled to the well logging system, the computer processor comprising functionality for:
obtaining raw data from a plurality of sources, the plurality of sources including sensor readings, generated reports, operational parameters, and production rates, wherein the raw data includes organized data and unorganized data;
integrating, using a robotic process automation (RPA), the organized data and the unorganized data;
performing, using the RPA, a plurality of statistical calculations on the integrated data;
generating, using the RPA, a report based on the performed statistical calculations; and
performing, using the computer processor, a maintenance operation in response to the report.

16. The system of claim 15, wherein integrating the organized data and unorganized data extracted from the raw data comprises:
cleaning, using the computer processor and the RPA, the organized data and unorganized data by removing incorrect, corrupted, incorrectly formatted, duplicate, or incomplete organized data and unorganized data;
sorting, using the computer processor and the RPA, the cleaned data according to a predetermined order; and
transforming, using the computer processor and the RPA, the sorted data into a predetermined format.

17. The system of claim 16, wherein transforming the sorted data includes data wrangling and mapping data into the predetermined format.

18. The system of claim 15, wherein the statistical calculations may be performed on field data, sensor data, production rates, and real-time updates for a plurality of oil fields.

19. The system of claim 15, wherein the maintenance operation comprises replacing wellbore equipment components.

20. The system of claim 15, wherein the maintenance operation comprises adjusting operating parameters of a wellbore equipment to prevent failure.
